(19) United States
(12) Patent Application Publication
(10) Pub. No.: US 2004/0254699 A1
(43) Pub. Date: Dec. 16, 2004

(54) Operation input device

(76) Inventors: Masaki Inomae, Anjo-shi (JP); Yuji Tsuchiya, Okazaki-shi (JP); Rieko Fukushima, Kariya-shi (JP)

Correspondence Address: POSZ & BETHARDS, PLC, 11250 ROGER BACON DRIVE, SUITE 10, RESTON, VA, 20190, US

(21) Appl. No.: 10/839,796

(22) Filed: May 6, 2004

(30) Foreign Application Priority Data
May 8, 2003 (JP) 2003-130593

(51) Int. Cl. G06F 17/00

(52) U.S. Cl. 701/36; 701/1

(57) ABSTRACT

An operation input device includes a liquid crystal display and a Fresnel lens in combination to display a three-dimensional virtual image in a virtual space in front of a vehicle navigator' seat for allowing an occupant of the seat to input an operation command for an in-vehicle unit. An image of the occupant and the image in the virtual space are taken by an image pickup device. An ECU recognizes a motion of an occupant hand within the virtual space through an image processing operation performed against the picked-up images. When the recognized motion matches with a predetermined motion relative to the three-dimensional image displayed in the virtual space, it is determined by the ECU that an operation command for the in-vehicle unit has been inputted. The ECU outputs the operation command to the in-vehicle unit and changes the three-dimensional image in the virtual space according to the operation command.

### BACKGROUND OF THE INVENTION

1. Field of the Invention

The present invention relates to an operation input device constructed to identify from a motion of a user's hand an operation command issued by the user and output the identified operation command to a device to be operated.

2. Description of the Related Art

Input devices are conventionally known, which are constructed such that, in order to enable a vehicle occupant to operate an in-vehicle unit without touching the unit directly, a space to which the vehicle occupant can stretch its hand while sitting on a seat is provided as a virtual space, an image in the virtual space is taken or picked up so as to recognize a motion of the occupant's hand within the virtual space from the picked-up image, and an operation command issued by the occupant is determined based on the recognized motion of the occupant's hand. One example of such conventional input devices is disclosed in Japanese Patent Laid-open Publication (JP-A) No. 2000-75991.

According to the disclosed input device, the vehicle occupant can operate various in-vehicle units or devices including an air-conditioner, a navigation unit and so on without involving direct contact with a control panel of each unit. Thus, input operation with respect to the individual in-vehicle units can be achieved with utmost ease.

Furthermore, to avoid false input, the disclosed input device is arranged such that a result of determination performed on the operation command is called back to the vehicle occupant by way of a voice message. Thus, even if the input device for the operation command makes a false determination, the occupant moving its hand within the virtual space can cancel the result of such false determination.

However, for operation of the in-vehicle units by the conventional input device, the vehicle occupant is required to move its hand within the virtual space where nothing is present other than the occupant hand. This requirement may raise a problem that the usability of the input device is very low particularly for a vehicle occupant who is inexperienced at operation within the virtual space. Furthermore, another problem is that when the input device for the operation command makes a false determination, the result of such false determination cannot be successfully canceled even though the vehicle occupant is made aware of such false operation by a voice callback message.

### SUMMARY OF THE INVENTION

With the foregoing problems in view, it is an object of the present invention to provide an operation input device of the type described, which is improved in its usability to the extent that the user can easily and reliably operate a device to be operated.

To achieve the foregoing object, according to the present invention, there is provided an operation input device comprising: three-dimensional image display means for displaying a three-dimensional image in a predetermined virtual space; one or more image pickup means for picking up an image in an area including the virtual space; and recognition means for recognizing a motion of a user' hand within the virtual space from the image picked up by the image pickup means. The operation input device also includes a control means that is configured to cause or drive the three-dimensional image display device to display a three-dimensional image for operation of a device to be operated, identify an operation command issued by the user from the motion of the user's hand recognized by the recognition means while the three-dimensional image is displayed, change the three-dimensional image displayed by the three-dimensional image display means in accordance with the identified operation command, and outputs the operation command to the device to be operated.

With the operation input device thus arranged, the user is allowed to input a desired operation command with respect to the device to be operated by properly moving (pushing, grasping or waving) its hand within the virtual space while visually confirming the three-dimensional image displayed in the virtual space for actuation by the user. Thus, the user is no longer required to move its hand within a space in which nothing is present as in the conventional operation input device. Accordingly, the usability of the operation input device of the present invention is very high as compared to the conventional device, and a false operation by the user can be avoided.

Furthermore, since the three-dimensional image displayed in the virtual space for actuation by the user changes according to the operation command identified by the control means, the change in the three-dimensional image enables the user to confirm a result of the actuation with reliability. Even when a false actuation by the user takes place, it is readily possible to recover the false actuation by repeating the actuation again while observing the three-dimensional image. This will further improve the usability of the operation input device.

It is true that by displaying a three-dimensional image in the virtual space for actuation by the user, the operation input device of the present invention can improve the usability when the user moves its hand within the virtual image to input an operation command. In an application where input of an operation command to each of plural devices to be operated is a major requirement, or when the device to be operated has many sorts of operations to controlled, it is practically impossible to display all items of information operable by a single three-dimensional image.

In this case, it is preferable that the control means, before driving the three-dimensional image display means to display the three-dimensional image for operation of the device to be operated, drives the three-dimensional image display means to display a three-dimensional image for allowing a user to perform selection of a device to be operated or a sort of operation of a device to be operated, identifies the device to be operated or the sort of operation selected by the user from the motion of the user's hand recognized by the recognition means while the three-dimensional image is displayed, and subsequently, in accordance with a result of recognition, drives the three-dimensional image display means to display a three-dimensional image for operation of the device to be operated.

With the control means thus arranged, the user is able to select a desired device to be operated or a desired sort of operation to be performed, by merely moving its hand within the virtual space while visually observing a three-dimensional image displayed in the virtual space for the purpose of selection. Based on the selection thus made, a three-dimensional image for actuation by the user is displayed in the virtual space. This will ensure that both for the plural devices to be operated and for the numerous sorts of operations to be performed, an operation command can be inputted through a simple action taken by the user.

In this case, the three-dimensional images provided for the selection of the device to be operated or the sort of operation to be performed are preferably layered or hierarchized in advance in a like manner as a general hierarchical menu so that the user can change the hierarchically configured three-dimensional images in succession until a desired three-dimensional image is selected for actuation by the user.

The three-dimensional image displayed in the virtual space for actuation by the user may take the form of three-dimensionally displayed buttons or controls. It is preferable to detect actual operating conditions of a device to be operated and display the detected operating conditions through a three-dimensional image. This arrangement allows the user to input a desired operation command with immediate confirmation of the actual operating conditions of the operated device that are acquired from the displayed image. In this instance, since a result of input of the operation command is displayed within the virtual space as a change in operating conditions of the operated device, the user can readily confirm the result of the operation command input operation.

The operation input device may be a vehicle operation input device, which is constructed to allow an occupant of a vehicle to operate an in-vehicle unit. In the vehicle operation input device, the three-dimensional image display means is disposed in front of a seat of the vehicle and arranged to have the virtual space formed by a space to which the occupant of the seat can stretch its hand and also have the three-dimensional image displayed to an occupant sitting on the seat. The image pickup means is disposed in front of the seat of the vehicle together with the three-dimensional image display means and arranged to take or pick up an image of the occupant of the seat from the front of the occupant.

With the vehicle operation input device thus arranged, the occupant of the vehicle seat can readily operate the in-vehicle unit without being urged to change its sitting position on the vehicle seat.

### BRIEF DESCRIPTION OF THE DRAWINGS

FIG. 1 is a diagrammatical view showing the general arrangement of an operation input device according to an embodiment of the present invention;

FIG. 2 is a block diagram showing the arrangement of an electric control unit (ECU) for operation input and other ECUs for various in-vehicle units that are connected with the operation input ECU via a communication channel;

FIG. 3 is a flowchart showing control procedure carried out by the operation input ECU; and

FIGS. 4A through 4D are pictorial views showing the manner in which operation of an in-vehicle unit is controlled using three-dimensional images displayed in a virtual space of the operation input device of the present invention.

### DETAILED DESCRIPTION OF THE PREFERRED EMBODIMENT

One preferred structural embodiment of the present invention will be described in detail herein below, by way of example only, with the reference to the accompanying sheets of drawings, in which identical or corresponding parts are denoted by the same reference characters throughout views.

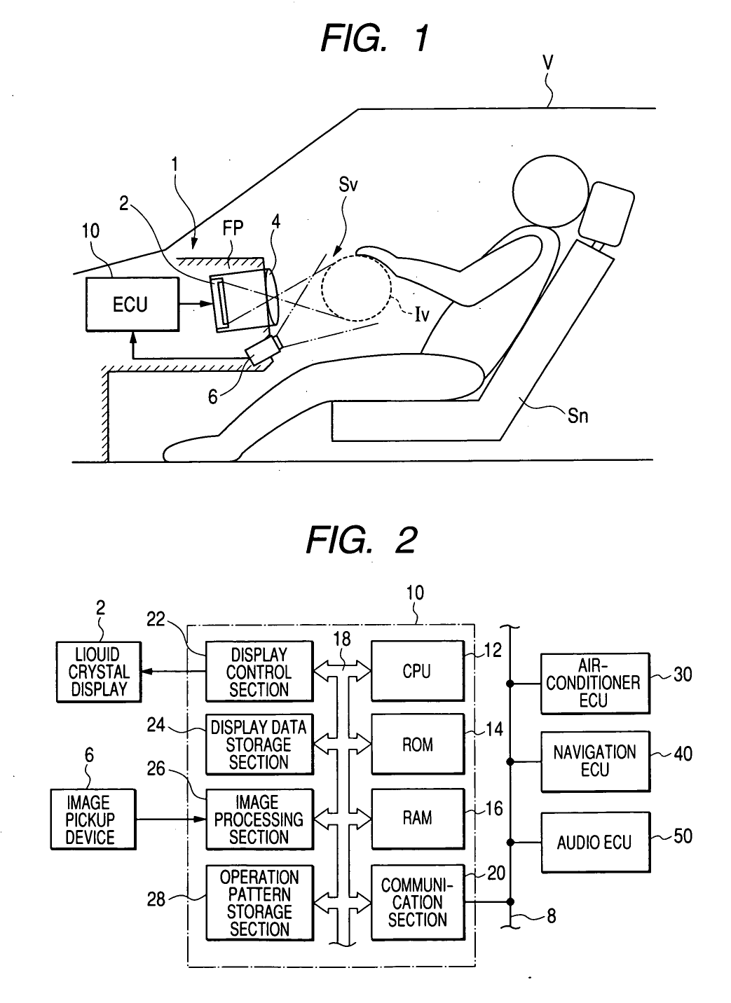

FIG. 1 diagrammatically shows the general arrangement of an operation input device embodying the present invention. As shown in this figure, the operation input device 1 is installed in a vehicle V for inputting operation commands or instructions given by an occupant Pn of a navigator's seat Sn of the vehicle V. The operation input device 1 generally comprises a liquid crystal display 2 and a Fresnel lens 4 that are disposed on a vehicle front panel FP in front of the occupant seat Sn, an image pickup device 6 disposed on the front panel FP, and an electronic control unit 10 for operation input. The electric control unit 10 is hereinafter referred to as “operation input ECU”.

The liquid crystal display 2 and the Fresnel lens 4 together form a three-dimensional image display means or unit of the invention, which is constructed to emit light information in such a manner that each eye of the occupant Pn of the seat Sn views a different image with the result that a virtual image Iv (three-dimensional image) is displayed in a space Sv (virtual space) to which the occupant Pn can stretch its hand or hands while keeping a sitting position on the seat Sn.

More specifically, the liquid crystal display 2 includes a liquid crystal display panel that displays parallactic first and second images (i.e., stereoscopic images) alternately in time sharing, and two light sources that emit light beams alternately from different directions onto the liquid crystal display panel so that the first and second images displayed on the liquid crystal display panel are selectively projected on the respective eyes of the occupant Pn. The Fresnel lens 4 disposed in front of the liquid-crystal display panel converts the stereoscopic images displayed on the liquid crystal display panel into a virtual image (three-dimensional image) of enlarged size.

The structure of the liquid crystal display 2 is well known, as disclosed in, for example, Japanese Patent Laid-open Publications Nos. 9-222584, 2000-50316 and 2001-218231, and further description thereof can be omitted.

The image pickup device 6 comprises a charge-coupled device (CCD) camera that can take or pick up an image (two-dimensional image) in an area located in front of the occupant Pn and including the virtual space Sv where the three-dimensional image is displayed by means of the liquid crystal display 2 and the Fresnel lens 4. The image pickup device 6 forms an image pick-up means of the invention.

For controlled operation of various in-vehicle units including an air-conditioner, a navigation unit and an audio unit, the operation input ECU 10 is configured to urge or drive the liquid crystal display 2 to display a three-dimensional image Iv inside the virtual space Sv, read a picked-up image taken by the image pickup device 6 while the image is displayed on the liquid crystal display 2, read an image taken or picked up by the image pickup device 6 during display of the three-dimensional image, perform an image processing operation for the picked-up image so as to recognize a motion of an occupant' hand inside the virtual space Sv, and identify from the result of recognition an operation command issued by the occupant Pn.

As shown in FIG. 2, the operation input ECU 10 is comprised of a microcomputer per se known, which includes a central processing unit (CPU) 12, a read-only memory (ROM) 14, a random access memory (RAM) 16 and a bus line interconnecting the CPU12, ROM 14 and RAM 16.

The operation input ECU 10 further includes a display control section 22 for driving the liquid crystal display 2 to display stereoscopic images, a display data storage section 24 for storing therein display data used for driving the liquid crystal display 2 to display the stereoscopic images, an image processing section 26 for processing a picked-up image taken by the image pickup device 6 so as to recognize a position or form of the hand of the occupant as a user, an operation pattern storage section 28 for storing therein operation patterns used for identification, from a motion of the occupant's hand, of an operation command issued by the occupant, and a communication section 20 that performs data communication between itself and an air-conditioner ECU 30, a navigation ECU 40 and an audio ECU 50 of the in-vehicle units through the communication line 8.

By virtue of the operation of the CPU 12 incorporated in the operation input ECU 10, the liquid crystal display 2 is driven to display a three-dimensional image Iv (FIG. 1) within the virtual space Sv (FIG. 1) for operation of an in-vehicle unit, an operation command issued by the occupant as a user, is identified from a picked-up image taken by the image pickup device 6, and the identified operation command is transmitted to the air-conditioner ECU 30, navigation ECU 40 and audio ECU 50 so that operation of the corresponding in-vehicle units (i.e., the air-conditioner, navigation unit and audio unit) are controlled by the respective ECUs 30, 40, 50.

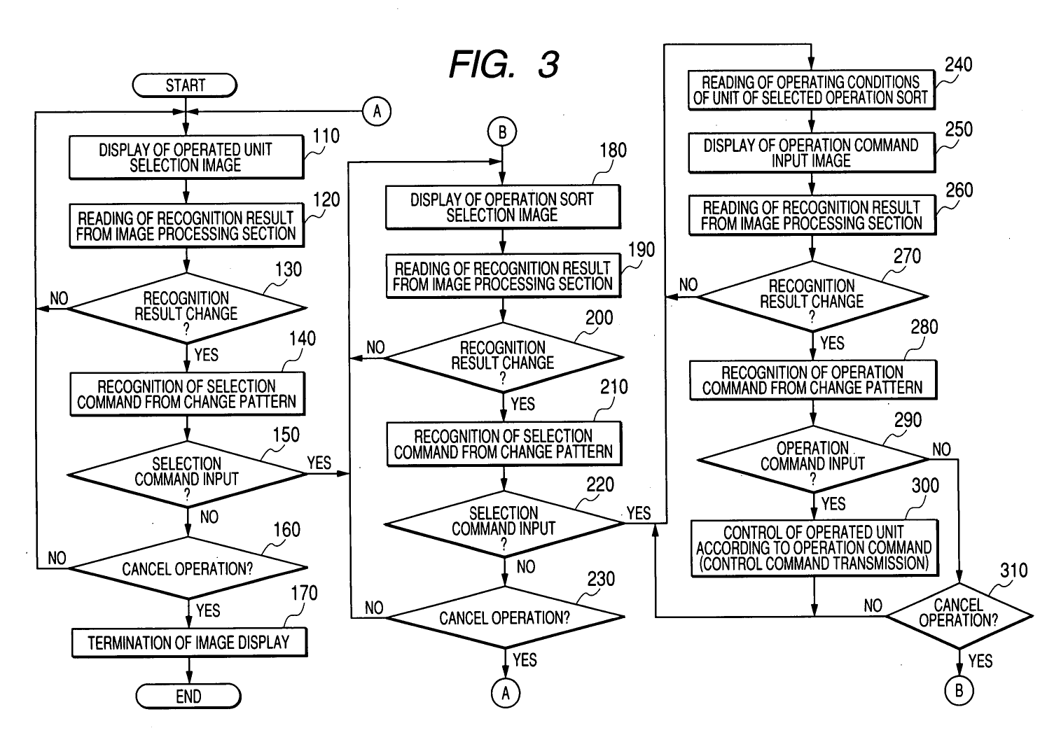

A control procedure achieved by the operation input ECU 10 (more properly the CPU 12) so as to accept entry of operation commands from the occupant Pn will be described below with reference to a flowchart shown in FIG. 3.

In executing the control procedure, it is assumed that as display data for displaying three-dimensional images, operated unit selection images that allow the occupant to select a desired in-vehicle unit to be operated from among the in-vehicle units, operation sort selection images that allow the occupant to select a desired sort of operation to be performed from among operation sorts of each of the in-vehicle units, and operation command input images corresponding to respective ones of the operation sorts selectable by the occupants are stored in the display data storage section 24 in a layered or hierarchical form.

Similarly, various operation patterns each corresponding to one of the images stored in the display data storage section 24 are stored in the operation pattern storage section 28 for enabling identification of a selection command or an operation command issued by the occupant from a motion of the occupant's hand while each respective image is displayed within the virtual space Sv (FIG. 1).

As shown in FIG. 3, the CPU 12 starts to execute the control procedure from a step 110. At the step 110, display data about operated unit selection images are read from the display data storage section 24 and delivered to the display control section 22 whereupon the liquid crystal display 2 is driven to display a three-dimensional image in the virtual space for the selection of a desired in-vehicle unit to be operated (hereinafter referred to, for brevity, as “operated unit”). In the illustrated embodiment, because the number of operated in-vehicle units are three (i.e., the air-conditioner, navigation unit and audio unit), three selection blocks or balls each representing a corresponding one of the operated units are displayed within the virtual space as if they are floating in the air.

Subsequently at a step 120, a recognition result obtained for the position and form of an occupant's hand through an image processing operation against a picked-up image is read from the image processing section 26. Thereafter, a step 130 determines whether or not the read recognition result (the position and form of the occupant's hand) shows a change created after the last or preceding reading process at the step 120.

If a determination result at the step 130 is negative (i.e., when the recognition result is judged as not showing a change developed after the last reading), the control procedure returns to the step 110. Alternatively, if the determination result at the step 130 is affirmative (i.e., when the recognition result is judged as showing a change developed after the last reading), the control procedure advances to a step 140. At the step 140, a change pattern of the position or form of the occupant's hand is computed from the past recognition results obtained at the image processing section 26 and the computed change pattern is compared with an operation pattern stored in the operation pattern storage section 28 to thereby recognize a selection command inputted by the occupant through a motion of the occupant hand within the virtual space.

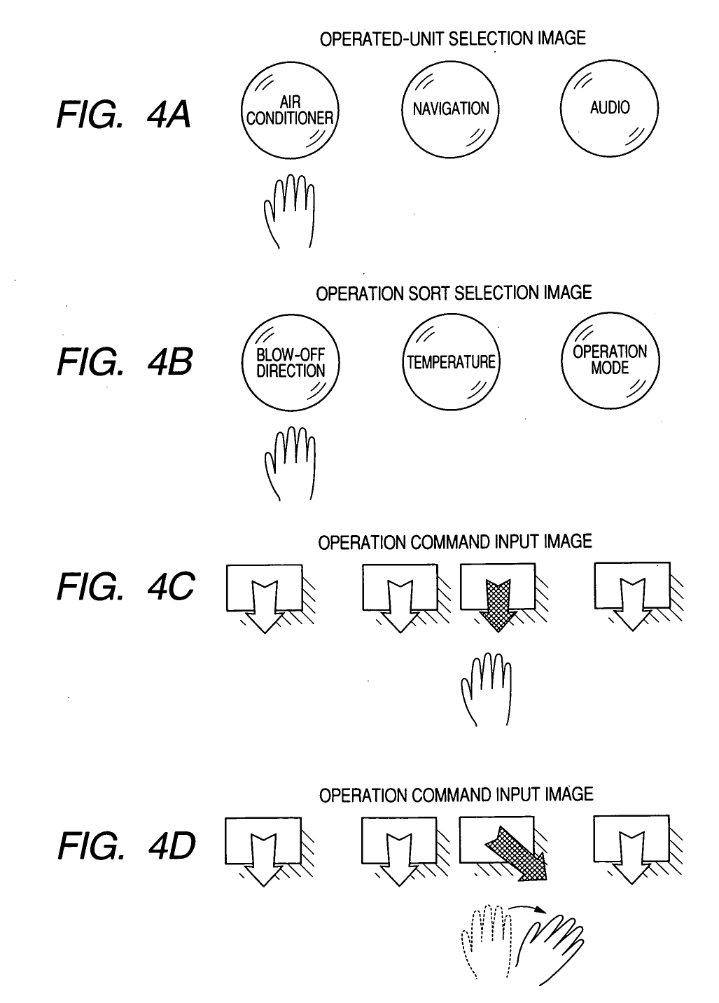

In the illustrated embodiment, the operation pattern used during display of the operated unit selection image is set such that when a hand of the occupant which has been stretched ahead of a desired one of the selection blocks being displayed, as shown in FIG. 4A, is moved in such a manner as to press or grasp the desired selection block, it is determined that the pressed or grasped selection block is selected.

The step 140 is followed by a step 150 where a judgment is made to determine whether or not input of the selection command from the occupant has been recognized through the selection command recognition process performed at the step 140. If a judgment result is affirmative (i.e., when input of the selection command has been recognized), the control procedure branches to a step 180. Alternatively, if the judgment result is negative (i.e., when input of the selection command has not been recognized), the control procedure advances to a step 160. At the step 160, a judgment is made to determine whether or not a cancel operation by the occupant has been recognized through the selection command recognition process performed at the step 140.

The cancel operation is defined as being represented by a waving motion of the occupant hand in left and right directions across the virtual space. The step 140 also performs identification of the thus defined cancel operation based on a motion of the occupant hand.

If the judgment result at the step 160 shows that the cancel operation has not been recognized, the control procedure returns to the step 110. Alternatively, if the judgment result at the step 160 shows that the cancel operation has been recognized, this means that the operation input using the virtual space has been cancelled. Thus, the control procedure advances to a step 170, which terminates display of the image.

The CPU 12 is configured such that even after termination of the control procedure, it reads or obtains the recognition result from the image processing section 26 and performs an activation command recognition process to recognize an activation command of the occupant based on a change pattern acquired for the motion of the occupant's hand. Upon recognition of the activation command of the occupant, the CPU 12 restarts the control procedure to execute the operations from the step 110 onward.

The step 180, which is executed when the judgment result at the step 150 shows that selection command from the occupant has been recognized, reads display data about operation sort selection images and delivers the display data to the display control section 22 so that an operation sort selection image is displayed within the virtual space for enabling the occupant to select a desired sort of operation that is selected by the selection command.

As a consequence, selection blocks each representing one of the sorts of operation of the operated unit selectable by the occupant are displayed within the virtual space. For example, in the illustrated embodiment, it is determined in advance that sorts of operation of the air-conditioner include (a) a wind direction setting operation for setting the blow-off direction of conditioned air from each of four air vents disposed respectively on a left end, a right end, and left and right sides proximate to the center of a front part of a vehicle passenger compartment, (b) a temperature setting operation for setting the temperature inside the passenger compartment or the temperatures of conditioned air discharged from the individual air vents, and (c) operation mode setting operation for setting an operation mode of the air-conditioner (between an automatic operation mode and a manual operation mode, and between a flesh-air intake mode and a room-air circulation mode when the manual operation mode is selected). In the case where the selection block representing the air-conditioner is selected from among three selection blocks displayed as the operated unit selection image, as shown in FIG. 4A, three selection blocks or balls each representing a respective one of the foregoing three sorts of operation (a)-(c) are displayed within the virtual space just as floating in the air, as shown in FIG. 4B.

Subsequently at a step 190, the result of recognition of the position and form of an occupant's hand obtained through an image processing operation performed against a picked-up image is read from the image processing section 26 in the same manner as done in the step 120. Thereafter, a step 200 determines whether or not the read recognition result (the position and form of the occupant's hand) shows a change developed after the last or preceding reading process at the step 190.

If a determination result at the step 200 is negative (i.e., when the recognition result is judged as not showing a change produced after the last reading), the control procedure returns to the step 180. Alternatively, if the determination result at the step 200 is affirmative (i.e., when the recognition result is judged as showing a change developed after the last reading), the control procedure advances to a step 210. At the step 210, a change pattern of the position or form of the occupant's hand is computed from the past recognition results obtained at the image processing section 26 and the computed change pattern is compared with an operation pattern stored in the operation pattern storage section 28 to thereby recognize a selection command inputted by the occupant through a motion of the occupant hand within the virtual space.

The operation pattern used in combination with the operation sort selection image for recognizing of a selection command is the same as the operation pattern used in combination with the operated unit selection image for recognizing a selection command. Stated more specifically, as shown in FIG. 4B, the operation pattern is set such that when a hand of the occupant which has been stretched ahead of a desired one of the selection blocks being displayed is moved in such a manner as to press or grasp the desired selection block, it is determined that the pressed or grasped selection block is selected.

The step 210 is followed by a step 220, which makes a judgment to determine whether or not input of the selection command from the occupant has been recognized through the selection command recognition process achieved by the step 210. If the result of judgment is affirmative (i.e., when input of the selection command has been recognized), the control procedure branches to a step 240. Alternatively, if the judgment result is negative (i.e., when input of the selection command has not been recognized), the control procedure advances to a step 230 where a further judgment is made to determine whether or not a cancel operation by the occupant has been recognized through the selection command recognition process achieved at the step 210.

If the judgment result at the step 230 shows that the cancel operation has not been recognized, the control procedure returns to the step 180. Alternatively, if the judgment result at the step 230 shows that the cancel operation has been recognized, this means that the operation input with respect to the operated unit selected by the occupant has been cancelled. The control procedure then returns to the step 110.

The step 240 is executed when the judgment result at the step 220 shows that selection command from the occupant has been recognized. At this step 240, operating conditions of the operated unit, which are corresponding to the operation sorts selected by the selection command, are read by data communication from the ECU associated with the operated unit (i.e., the air-conditioner ECU 30, navigation ECU 40, or audio ECU 50).

Subsequently at a step 250, display data about operation command input images corresponding to the operation sorts are read from the display data storage section 24 and, based on the display data and the operating conditions of the operated unit obtained at the step 240, an operation command input image with the operating conditions reflected thereon is generated and outputted to the display control section 22 as final display data. Consequently, an operation command input image representing the operating conditions of the operated unit is three-dimensionally displayed in the virtual space.

For example, when the wind direction setting operation is selected as a sort of operation while the operation sort selection image for the air-conditioner is displayed as shown in FIG. 4B, the step 250 generates an image to be displayed in the virtual space as a three-dimensional image. As shown in FIG. 4C, the generated image includes an operation command input image read from the display data storage section 24 as showing four air vents in a front part of the vehicle passenger compartment, and an image (taking the form of an arrow in the illustrated embodiment) showing the blow-off direction of conditioned air from each respective air vent of the air-conditioner as representing current operating conditions, the two images being arranged in overlapped condition.

Subsequently at a step 260, the result of recognition of the position and form of an occupant's hand obtained through an image processing operation performed against a picked-up image is read from the image processing section 26 in the same manner, as done in the step 120 or the step 190. Thereafter, a step 270 determines whether or not the read recognition result (the position and form of the occupant's hand) shows a change created after the last or preceding reading process at the step 260.

If the result of determination at the step 270 shows that the recognition result indicates no change created after the last reading, the control procedure returns to the step 240. Alternatively, if the determination result at the step 270 shows that the recognition result indicates a change created after the last reading, the control procedure advances to a step 280. At the step 280, a change pattern of the position or form of the occupant's hand is computed from the past recognition results obtained at the image processing section 26 and the computed change pattern is compared with an operation pattern stored in the operation pattern storage section 28 to thereby recognize an operation command inputted by the occupant through a motion of an occupant's hand within the virtual space.

The operation pattern used in combination with the operation command input image for recognizing an operation command, thought it varies with the form of the operation command input image, is generally set to change operating conditions of a unit being displayed in the operation command input image. For example, in case of the operation command input image shown in FIG. 4C, the operation pattern is set such that when a hand of the occupant, which has been stretched ahead of one of the air vents for which the occupant is desirous of changing the blow-off direction of conditioned air, is moved in a desired direction, it is recognized that the blow-off direction of conditioned air from the desired air vent is to be changed in the direction of movement of the occupant's hand.

The step 280 is followed by a step 290 where a judgment is made to determine whether or not the operation command from the occupant has been recognized through the operation command recognition process performed at the step 280. If the judgment result is affirmative (i.e., when the operation command has been recognized), the control procedure advances to a step 300. At the step 300, the operation command recognized at the step 280 is transmitted to the ECU of the operated unit (i.e., the air-conditioner ECU 30, navigation ECU 40, or audio ECU 50) for controlling operation of the operated unit in accordance with the operation command. Thereafter, the control procedure returns to the step 240.

In this instance, because operating conditions of the operated unit acquired after transmission of the operation command are read or obtained at the step 240, an operation command input image displayed via a display operation performed at the following step 250 will reflect the operating conditions of the operated unit acquired after the input of the operating command, as shown in FIG. 4D. Through observation of the operation command input image, the occupant is able to confirm a control result occurring after the operation command is inputted.

Alternatively, if the judgment result at the step 290 is negative (i.e., when the operation command has not been recognized), the control procedure branches to a step 310 where a further judgment is made to determine whether or not a cancel operation by the occupant has been recognized through the operation command recognition process achieved at the step 280.

If the result of judgment at the step 310 shows that the cancel operation has not been recognized at the step 280, the control procedure returns to the step 240. Alternatively, if the judgment result at the step 310 shows that the cancel operation has been recognized at the step 280, this means that the operation input with respect to the sort of operation selected by the occupant has been cancelled. The control procedure then returns to the step 180.

As described above, according to the operation input device of the present invention, a three-dimensional image for inputting an operation command is displayed in a virtual space in front of a navigator's seat of a vehicle. When an occupant sitting on the navigator's seat moves its hand within the virtual space, an operation command is recognized from a motion of the occupant's hand and the recognized operation command is transmitted to an in-vehicle unit to be operated.

With the operation input device thus arrangement, the occupant as a user is allowed to input a desired operation command with respect to the operated unit by moving its hand within the virtual space while visually confirming the three-dimensional image displayed in the virtual space for the input of the operation command. This procedure improves the usability of the operation input device and effectively precludes the occurrence of a false operation by the user.

The operation command input image displayed in the virtual space represents current operating conditions of the operated unit. Accordingly when the operated unit is controlled in accordance with an operation command inputted by the occupant, the operation command input image is renewed according to the result of control. This arrangement allows the occupant to confirm operating conditions occurring at the operated unit subsequent to the input of the operation command. Furthermore, even if a false operation takes place, the occupant can readily recover desired operating conditions of the operated unit by repeating the operation command input operation while observing the operation command input image. This will further improve the usability of the operation input device.

To enable detailed operation of plural in-vehicle units (i.e., an air-conditioner, a navigation unit and an audio unit), the operation input devices is provided with three different sorts of images to be displayed in the virtual space as three-dimensional images. The three different sorts of images include an image for selection of a unit to be operated, an image for selection of a sort of operation performed against the operated unit, and an image for the input of an operation command corresponding to the selected sort of operation. These images are displayed as three-dimensional images within the virtual space. By changing the images in steps, the occupant can readily select a desired operated unit from among plural in-vehicle units or a desired sort of operation from among many sorts of operation.

In the illustrated embodiment, the control procedure performed by the operation input ECU 10 constitutes a control means of the present invention. Especially, the steps 120, 130, 190, 200, 260 and 270 that are executed for recognizing a motion of the occupant hand and the image processing section 26 in the operation input ECU 10 constitute a recognition means of the present invention.

Although only one embodiment of the invention has been disclosed and described, it is apparent that other embodiments and modifications of the invention are possible.

For instance, in the illustrated embodiment, the invention is embodied in a vehicle operation input device for operating plural in-vehicle units. The same effects as described above can be also achieved when the invention is embodied in an operation input device designed to operate a single in-vehicle unit or one or more units other than the in-vehicle units.

In the latter case, the invention is particularly advantageous when embodied in a railway ticket-vending machine where the user is required to operate buttons on an operation panel while looking at another display means such as a fare table. In such application, it will be appreciated that the railway ticket-vending machine is arranged to provide a railway map displayed as a three-dimensional image within a virtual space, change the railway map in response to an action taken by the user to move the railway map using the three-dimensional image, and display a fare when the user identifies a final destination on the displayed railway map. By thus arranging the railway ticket-vending machine, the user can purchase a desired railway ticket with greater ease as compared to the conventional railway ticket-vending machines.

Although in the embodiment discussed above, description of a control procedure achieved to operate the navigation unit has been omitted, it can be appreciated that when a map on a display screen of the navigation unit is to be changed, a map is displayed as a three-dimensional image in the virtual space and is changed in response to an action of the occupant tending to move the map on the three-dimensional image whereupon the map on the display screen of the navigation unit changes correspondingly. Thus, when the occupant performs an operation to designate a viewpoint on the three-dimensional image, the map on the navigation unit changes in correspondence with the designated viewpoint.

In the illustrated embodiment, the image pickup device 6 is described as a single image pickup device. This is because the position of an occupant sitting on a navigator's seat of the vehicle is generally fixed and not greatly variable so that only using an image taken or picked up from a single direction can identify motions of an occupant hand. When the invention is applied to a device in which the position of a user is not fixed, a plurality of image pickup devices are used to pick up a corresponding numbers of image of the user so that a motion of a user's hand is recognized based on the plural picked-up images.

Similarly, in the case of an operation input device where the position of the user is not fixed and the position of the user's eyes varies greatly, it is difficult to precisely display a three-dimensional image within a virtual space for actuation by the user. In this case, it is preferable that the position of the user (more properly, the positions of the user's eyes) are detected and, based on a detection result, a parallax of stereoscopic images to be displayed on the liquid crystal display panel of a liquid crystal display is adjusted.

The liquid crystal display 2 described in the illustrated embodiment as constituting an essential part of the three-dimensional image display means is only for purposes of explanation and not restrictive. The three-dimensional image display means may include other types of displays as long as they can display a three-dimensional image to the user. In one example of such displays, an image for a left eye and an image for a right eye are displayed side by side on a single liquid crystal display panel, and the direction of display of the images is changed over by a switch such as a liquid crystal shutter so that the respective images are viewed by the corresponding eyes of the user. In another example, a special eyeglass is used to observe a three-dimensional image.

Obviously, various minor changes and modifications are possible in the light of the above teaching. It is to be understood that within the scope of the appended claims the present invention may be practiced otherwise than as specifically described.

What is claimed is:

1. An operation input device comprising:
three-dimensional image display means for displaying a three-dimensional image in a predetermined virtual space;
one or more image pickup means for picking up an image in an area including the virtual space;
recognition means for recognizing a motion of a user' hand within the virtual space from the image picked up by the image pickup means; and
control means for driving the three-dimensional image display device to display a three-dimensional image for operation of a device to be operated, identifying an operation command issued by the user from the motion of the user's hand recognized by the recognition means while the three-dimensional image is displayed, causing the three-dimensional image displayed by the three-dimensional image display means to change in accordance with the identified operation command, and outputting the operation command to the device to be operated.

2. The operation input device according to claim 1, wherein the control means, before driving the three-dimensional image display means to display the three-dimensional image for operation of the device to be operated, drives the three-dimensional image display means to display a three-dimensional image for allowing a user to perform selection of a device to be operated or a sort of operation of a device to be operated, identifies the device to be operated or the sort of operation selected by the user from the motion of the user's hand recognized by the recognition means while the three-dimensional image is displayed, and subsequently, in accordance with a result of recognition, drives the three-dimensional image display means to display a three-dimensional image for operation of the device to be operated.

3. The operation input device according to claim 1, wherein the operation input device is a device actuatable by an occupant of a vehicle to operate an in-vehicle unit, the three-dimensional image display means is disposed in front of a seat of the vehicle and arranged to display the three-dimensional image to an occupant sitting on the seat with the virtual space formed by a space to which the occupant of the seat can stretch its hand, and the image pickup means is disposed in front of the seat of the vehicle together with the three-dimensional image display means and arranged to pick up an image of the occupant of the seat from the front of the occupant.
